(19) United States
(12) Patent Application Publication
(10) Pub. No.: US 2020/0391844 A1
(43) Pub. Date: Dec. 17, 2020

(54) Power and energy saving equipment for vehicles

(71) Applicant: Qiusheng Gao, Wujiang (CN)

(72) Inventor: Qiusheng Gao, Wujiang (CN)

(21) Appl. No.: 16/442,610

(22) Filed: Jun. 17, 2019

(51) Int. Cl. B64C 3/36; B64C 23/00

(52) U.S. Cl. CPC B64C 3/36; B60F 5/02; B64C 23/00

(57) ABSTRACT

Power and energy saving equipment can save the power to drive the vehicle forward at the same speed and save the energy consumed by the vehicle moving through the same distance at the same speed. When the vehicle with wing installed is moving forward, the pressure between top and bottom of the wing will create the lift force. This equipment utilizes the lift force created by the wing to reduce the friction force between the wheel and the ground.

Power and energy saving equipment can partially solve the serious energy shortage problem in the world with relatively low cost. It needs minor modification for the frame and chassis of the vehicle, so the lift force can be passed to the chassis on the vehicle, but it does not need to change the existing engine and driving system.

Power and energy saving equipment can be applied to many different type of vehicles such as car, truck, boat and train.

### TECHNICAL FIELD

The present invention generally relates to improvements in power and energy saving for vehicles, which utilize the lift force with properly installed wings. When vehicles with wings installed are moving forward, lift force is created by different pressures on two sides of a wing. The lift force can reduce the friction force between the wheel and ground: friction force=(weight of vehicle−lift force) times friction coefficient. The power driving the vehicle equals velocity of the vehicle timing (friction force between vehicle and ground+resistive force between vehicle and air), so the vehicle needs less driving power for the same velocity. The energy consumed by the vehicle equals the power timing the period of time vehicle moved, so the vehicle consumes less energy for the same distance at the same velocity.

The reduced friction force also can make the vehicle speed up time shorter with the same engine since the vehicle has less total resistive force.

Generally, the higher the velocity of the vehicle, the bigger the lift force is created by the wing. An adjustable wing similar to the wing used in existing modern airplane can maximize the lift force created, hence optimizes the power and energy saved by the vehicle.

There is no change for the current engine and driving system.

### BACKGROUND ART

Currently, most vehicles use the gas to generate power to drive the vehicle forward. Due to the expense of the gas and the environmental pollution by the gas engine, some vehicles use the electricity to drive the vehicle forward. Due to the large amounts of vehicles in use, vehicles consume lots of energy in the world. Energy saving technology is very important for vehicles. A simple pair of wings with pretty low cost could easily save the energy consumed by the vehicle by 10%-40%.

### SUMMARY OF THE INVENTION

An object of the present invention is to utilize the lift force of the wing to reduce the friction force between the vehicle wheel and the ground. The vehicle needs less power to move forward and consumes less energy for the same velocity with the reduced friction force. The current engine and driving system of the vehicle is not changed.

In accordance with the present invention, there is one or multiple pairs of wings installed on top or side of the vehicle. FIG. 1 and FIG. 2 show a simple rectangular wing with 4 tubes that fixes the wing to the top of the vehicle. FIG. 4 shows a pair of wings that is fixed to a stabilizer, which is attached to the top of the vehicle. There are many types of wings that cane be used to create lift force for vehicle. The way to fix the wings to the vehicle is not limited to 2 ways listed in FIG. 2 and FIG. 3, but the frame of the vehicle needs to be modified so that the lift force of the wing can be passed to the chassis of the vehicle.

In accordance with the present invention, when the vehicle is moving, the air flows longer distance on top of the wing than on the bottom of the wing, so the velocity of the air is higher on top of the wing than that on bottom. The velocity difference creates the pressure difference between top and bottom of the wing. The pressure difference creates the lift force in the wing. The lift force in the wing reduces the friction force between the ground and the wheel of the vehicle. According the equation: power=force×velocity, the vehicle needs less power to be driven forward at the same speed. According the equation: energy=power×time, the vehicle also consumes less energy at the same speed with a wing or multiple wings installed.

In accordance with the present invention, one wing or multiple wings can be installed on top or side of the vehicle. The lift force is changed with the speed of the vehicle. If the wing is adjustable to maximize the lift force created by the wing, it can optimize the energy being saved.

In accordance with the present invention, a vertical stabilizer shown in FIG. 3 can stabilize the motion of the vehicle.

### BRIEF DESCRIPTION OF THE DRAWINGS

FIG. 1 provides the primary horizontal view from the left side of the vehicle with a rectangular wing installed on top of the vehicle by 4 tubes.

FIG. 2 provides the 3-D view of the rectangular wing that is fixed to the top of vehicle by 4 tubes.

FIG. 3 provides 3-D view of a pair of wings that are attached to a vertical stabilizer, which is fixed to the top of the vehicle.

Note: Unless specified, vehicles can use the popular type of wings currently used by the airplane. The size and angles of the wings need further experiment based on the type and size of vehicles.

### DETAILED DESCRIPTION OF PREFERRED EMBODIMENTS

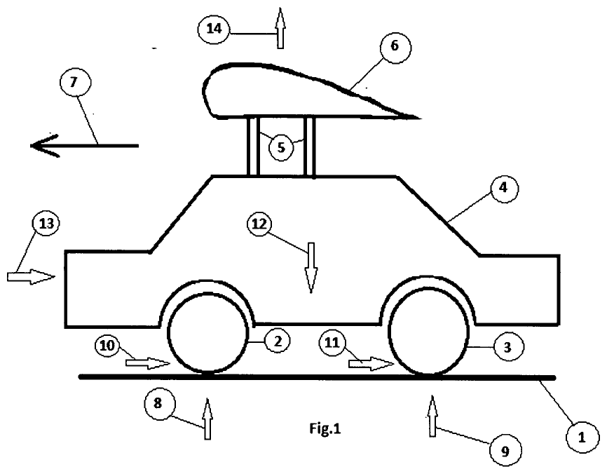

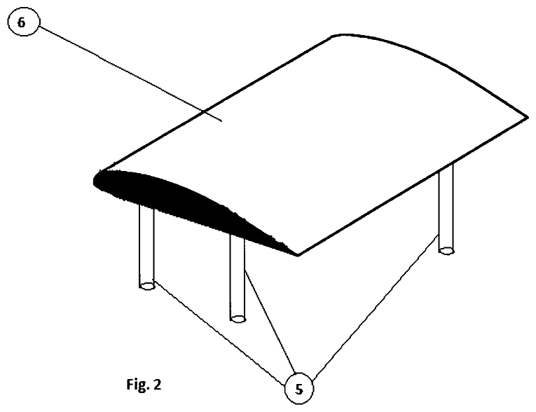

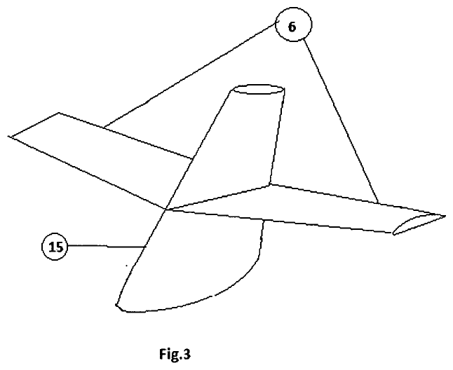

The power and energy saving equipment can be applied to all type of vehicles, e.g., cars, vans, trucks, boats and trains. The size and angles of the wing (6) needs further experiment based on the vehicle. One or multiple pairs of wings (6) are installed on top of the vehicle (4). There are different ways to install different type of wings (6) on top of the vehicles (4). FIG. 1 and FIG. 2 show that a rectangular wing (6) that is installed on top of the vehicle (4) using 4 tubes (5). FIG. 3 shows that a vertical stabilizer (15) is installed on top of the vehicle (4) and a pair of wings are fixed to the stabilizer. The wing (6) should be made adjustable to different speed of vehicle to optimize the lift force. A pair of wings can also be installed on side of the vehicle like the airplane wings. Either the wing (6) is installed on top or side of the vehicle (4), the frame or the chassis of the vehicle (4) needs to be modified so the lift force can be passed to the chassis of the vehicle/

When the vehicle (4) is moving forward (7), there are a few forces acting on the vehicle (4): lift force (14), gravity (12), resistive force from air (13), friction force (10) (11) from front wheel (2) and rear wheel (3), supporting force (8) (9) on front wheel (2) and rear wheel (3). The friction force (10) (11) between the wheel (2) (3) and the ground (1) equals the supporting force (8) (9) timing the friction coefficient that is depending on the surface of the ground (1) and the wheel (2) (3). The supporting force (8) (9) on front wheel (2) and rear wheel (3) equals the gravity (12) minus the lift force (14). Therefore, the lift force (14) on the wing (6) will reduce the friction force (10) (11) on the front wheel (2) and rear wheel (3). The power that drives the vehicle (4) forward (7) equals (friction force (10) (11)+resistive force (13) from the air) timing the speed of the vehicle (4), so the vehicle (4) needs less power to be driven forward at the same speed if the friction force (10) (11) is reduced more than the additional resistive force added from the wing (6). The energy consumed by the vehicle (4) equals the power timing the period when the vehicle is moving, so the energy consumed by the vehicle (4) with wing (6) installed can be reduced.

Due to the reduced friction force (10) (11), the vehicle (4) with wing installed will be accelerated faster so the speed up process is improved with the same engine.

1. A power and energy saving equipment shown in FIG. 1 and FIG. 2 comprising:
a rectangular wing (6)
4 tubes (5) fixing the wing (6) to the top of the vehicle (4)
characterized in that the lift force (14) on the wing (6) can reduce the friction force (10) (11) between the wheel (2) (3) and ground (1) thereof save the power to drive the vehicle (4) forward (7) at the same speed and save the energy to be consumed by the vehicle (4) moving through the same distance at the same speed.

2. A power and energy saving equipment shown in FIG. 3 comprising:
a vertical stabilizer (15)
a pair of wings (6)
characterized in that the lift force (14) on the wing (6) can reduce the friction force (10) (11) between the wheel (2) (3) and ground (1) thereof save the power to drive the vehicle (4) forward (7) at the same speed and save the energy to be consumed by the vehicle (4) moving through the same distance at the same speed.

3. The power and energy saving equipment as claimed in claim 2 characterized in that the vertical stabilizer can stabilize the motion of the vehicle.

4. The power and energy saving equipment as claimed in claim 1 and claim 2 characterized in that vehicle (4) can be accelerated faster with reduced friction force (10) (11) thereof improve the speedup process of the vehicle with the same engine.

5. The power and energy saving equipment can use other type of wings not shown in claim 1 and claim 2 but used in existing airplane.

6. The power and energy saving equipment can use multiple pairs of wings to save more power and energy of the moving vehicle.

7. The power and energy saving equipment can install wings on the side of the vehicle with regular ways.

8. The power and energy saving equipment as claimed in claim 1, 2, 5, 6, 7 can make the wing adjustable as the modern landing air plane does to optimize the lift force created by the wing.

9. The power and energy saving equipment as claimed in claims 1, 2, 5, 6, 7 and 8 characterized in that the power and energy saving equipment can be applied to different type of vehicle such as car, van, truck, boat and train.
